(19) United States
(12) Patent Application Publication
(10) Pub. No.: US 2006/0098056 A1
(43) Pub. Date: May 11, 2006

(54) Fluid injection devices integrated with sensors and fabrication methods thereof

(75) Inventors: Chung-Cheng Chou, Taoyuan County (TW); Tsung-Wei Huang, Taipei City (TW); Kai-Pin Chou, Taoyuan County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/269,651

(22) Filed: Nov. 9, 2005

(30) Foreign Application Priority Data
Nov. 10, 2004 (TW) 93134255

(51) Int. Cl. B41J 2/05

(52) U.S. Cl. 347/65

(57) ABSTRACT

Fluid injectors integrated with sensors and fabrication thereof. The fluid injector comprises a substrate, a fluid chamber in the substrate with a structural layer thereon, at least one fluid actuator positioned on the structural layer, a linear resistive sensor communicating with the fluid chamber, a passivation layer on the structural layer covering the at least one actuator and the sensor, and a nozzle neighboring the fluid actuator and communicating with the fluid chamber through the passivation layer and the structural layer.

### BACKGROUND

The invention relates to fluid injection devices, and more particularly, to fluid injection devices integrated with sensors and fabrication methods thereof.

Typically, fluid injection devices are employed in inkjet printers, fuel injectors, biomedical chips and other devices. Among inkjet printers presently known and used, injection by thermally driven bubbles has been most successful due to reliability, simplicity and relatively low cost.

FIG. 1 is a cross section of a conventional monolithic fluid injector 1 disclosed in U.S. Pat. No. 6,102,530, the entirety of which is hereby incorporated by reference. A structural layer 12 is formed on a silicon substrate 10. A fluid chamber 14 is formed between the silicon substrate 10 and the structural layer 12 to receive fluid 26. A first heater 20 and a second heater 22 are disposed on the structural layer 12. The first heater 20 generates a first bubble 30 in the chamber 14, and the second heater 22 generates a second bubble 32 in the chamber 14 to inject the fluid 26 from the chamber 14.

The conventional monolithic fluid injector 1 using bubbles as a virtual valve is advantageous due to reliability, high performance, high nozzle density and low heat loss. As inkjet chambers are integrated in a monolithic silicon wafer and arranged in a tight array to provide high device spatial resolution, no additional nozzle plate is needed.

Structural layer 12 for conventional monolithic fluid injector 1, however, is low stress nitride. Besides sustaining heaters, the structural layer 12 is also used as an etching resistive layer for HF solution during the fabrication process. Thus, thickness and physical characteristics of the structural layer 12 directly affect injection quality and production yield. Accordingly, the etching process forming the fluid chamber not only critically affects dimensions of the fluid chamber, but also affects injection results of the fluid injection device.

Moreover, with thermal bubble actuating injection devices, incomplete filling of the fluid chamber can cause unstable injection and dry firing. Furthermore, dry firing can affect the injection device lifetime.

Conventionally, the etching process for forming a fluid chamber is monitored using dummy wafers for comparison before batch fabrication. However, etching parameters such as etchant concentration and solution temperature must be maintained constantly, and the use of dummy wafers may increase fabrication cost. Thus, methods for monitoring fluid chamber etching during fabrication or fluid chamber filling during injection are required.

### SUMMARY

The invention provides fluid injector devices integrated with sensors and fabrication methods thereof to improve printability by simultaneously measuring resistance of each heater of fluid injectors and comparing with standard operating resistance as reference for adjusting output operating parameters.

Accordingly, the invention provides a fluid injection device, comprising a substrate, a fluid chamber in the substrate with a structural layer thereon, at least one fluid actuator positioned on the structural layer, a line shape resistive sensor communicating with the fluid chamber, a passivation layer on the structural layer covering the actuators and the sensors, and a nozzle neighboring the fluid actuator and communicating with the fluid chamber through the passivation layer and the structural layer.

The invention also provides a fluid injection device, comprising a substrate, a fluid chamber in the substrate with a structural layer thereon, at least one fluid actuator positioned on the structural layer, a passivation layer on the structural layer covering the actuators and the sensors, a nozzle neighboring the fluid actuator and communicating with the fluid chamber through the passivation layer and the structural layer, and a cylinder shell sensor on the structural layer mounted in the passivation layer about the nozzle.

The invention further provides a method for fabricating a fluid injection device, comprising providing a substrate, forming a patterned sacrificial layer on the substrate, forming a linear resistive sensor on the sacrificial layer having a first end and a second end, forming a patterned structural layer on the substrate and covering the sacrificial layer and the linear resistive sensor exposing the first end and the second end, forming a fluid chamber in the body of the substrate, exposing the sacrificial layer, and removing the sacrificial layer to form a fluid chamber.

### DESCRIPTION OF THE DRAWINGS

The invention can be more fully understood by reading the subsequent detailed description in conjunction with the examples and references made to the accompanying drawings, wherein:

FIG. 1 is a cross section of a conventional monolithic fluid injector;

FIGS. 2A-2B are cross sections of an embodiment of a fabricating method of a fluid injection device according to the invention;

FIG. 2C is a cross section of the fluid injection device of FIG. 2B filled with fluid;

FIGS. 3A-3B are cross sections of an exemplary embodiment of a fabricating method for a fluid injection device according to the invention;

FIG. 3C is a cross section of the fluid injection device of FIG. 3B filled with fluid;

FIG. 4A is a schematic diagram of an equivalent circuit of line, fluid in the chamber (length L), and line according to an exemplary embodiment of the invention;

FIG. 4B shows a Wheatstone bridge circuit monitoring etching of the fluid chamber and filling ink in the fluid chamber;

FIG. 5 is a plan view of the fluid injection device with hybrid sensors according to the invention;

FIGS. 6A-6B are cross sections of an embodiment of a fabrication method for a fluid injection device taken along line I-I′ of FIG. 5;

FIG. 6C is a cross section of the fluid injection device of FIG. 6B filled with fluid;

FIG. 7A is a schematic view of the cylindrical shell capacitor according to the invention;

FIG. 7B is a partial cross section of the cylindrical shell capacitor of FIG. 7A; and

FIG. 8 is an equivalent circuit of capacitors C_{1 and C}₂ coupled to an operational amplifier.

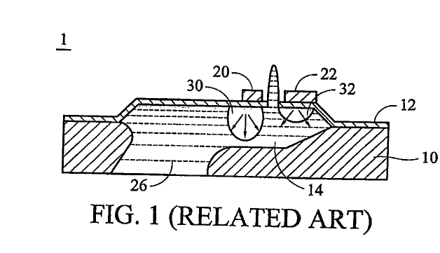

### DETAILED DESCRIPTION

Reference will now be made in detail to the preferred embodiments of the present invention, example of which is illustrated in the accompanying drawings.

Embodiments of the invention are directed to injection devices integrated with sensors and fabrication methods thereof. The sensors employ predetermined linear circuit layout monitoring etching of the fluid chamber during fabrication, thereby improving production yield during etching. Furthermore, by employing a cylindrical capacitor, fluid fill levels in a nozzle can be checked during injection.

Note that embodiments of the invention are not limited to thermal fluid injection devices. Other types of fluid injection devices, such as piezoelectric fluid injectors employing sensors measuring the thickness of a deformable layer are within the scope and spirit of the invention.

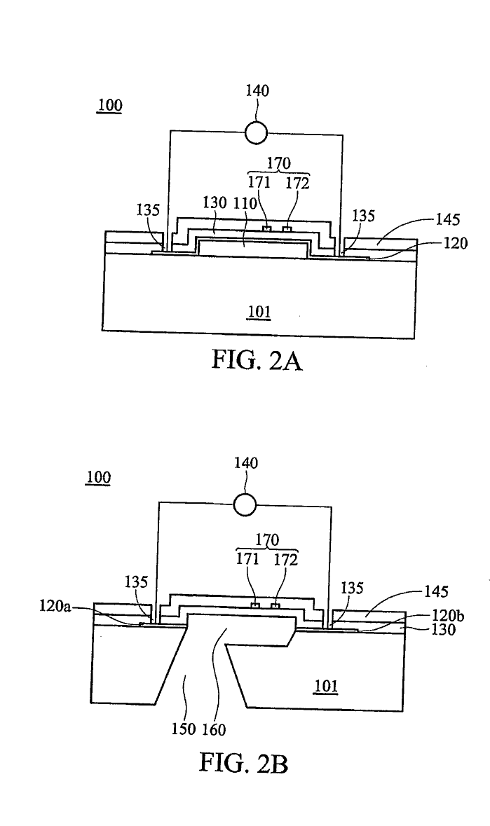

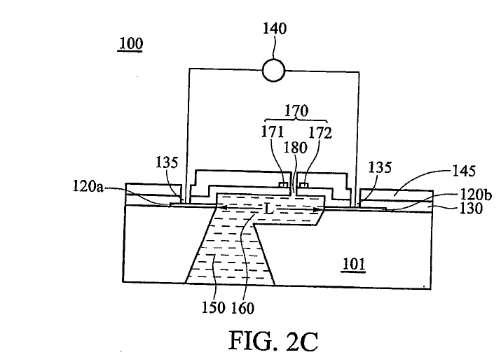

FIGS. 2A-2B are cross sections of an exemplary embodiment of a fabricating method of a fluid injection device according to the invention. FIG. 2C is a cross section of the fluid injection device of FIG. 23 filled with fluid.

Referring to 2A, a substrate 101 such as single crystalline silicon is provided. A patterned sacrificial layer 110 is formed on the substrate 101. The patterned sacrificial layer 110 may comprise chemical vapor deposition (CVD) of borophosphosilicate glass (BPSG), phosphosilicate glass (PSG), or other silicon oxide material with a thickness between approximately 6500 and 11000 Å. A conductive line, such as resistive line 120 is formed on the substrate 101 mounted on the structural layer 110. The resistive line 120 may made of doped polysilicon or other conductive materials. Sequentially, a patterned structural layer 130 is conformably formed on the substrate 101 covering the patterned sacrificial layer 110. The structural layer 130 is a low stress silicon nitride (Si₃N₄). The stress of the structural layer 130 is approximately 100 to 200 MPa. The low stress silicon nitride (Si₃N₄) is deposited by chemical vapor deposition (CVD). The structural layer 130 comprises two openings exposing two ends of the conductive line 140. According to an embodiment of the invention, an electrical meter such as an amperemeter is arranged to directly measure resistance or current of the conductive line 140.

Subsequently, a fluid actuator 170 is formed on the structural layer 130. A signal transmitting circuit (not shown) communicating with the fluid actuator 170 is formed. A passivation layer 180 is formed over the fluid actuator 170 and the signal transmitting circuit. The fluid actuator 170, for example a thermal bubble actuator, may comprise patterned resistors. The patterned resistors 170, serving as a heater, may comprise HfB₂, TaAl, TaN, or TiN deposited by physical vapor deposition (PVD), such as evaporation, sputtering, or reactive sputtering. The passivation layer 180 may be formed by chemical vapor deposition of silicon oxide.

The fluid actuator 170 may comprise a first heater 171 and a second heater 172 adjacent to and separated by predetermined nozzle position on the structural layer 130. When the injection device is activated, the first heater 171 generates a first bubble in the fluid chamber, and the second heater 172 generates a second bubble in the fluid chamber to inject the fluid from the fluid chamber.

Referring to FIG. 2B, the back of the substrate 101 is etched by wet etching to form a fluid channel 150, preferably using KOH, tetramethyl ammonium hydroxide (TMAH), or ethylene diamine pyrochatechol (EDP) solution. Further, the sacrificial layer 110 is etched and enlarged by wet etching to form a fluid chamber 160. According to an embodiment of the invention, bias is applied on the exposed ends of conductive line 120. With an electrical meter such as an ampere meter 140 arranged to directly measure resistance or current of the conductive line 120, the etching process can be monitored. When the resistance or current is supplied by the conductive line 120, the etch process continues. When resistance or current is supplied by the etching solution, i.e., the conductive line is interrupted, etching is stopped.

In FIG. 2A, the conductive line 120 is doped polysilicon or other conductive materials. The conductive line 120 is arranged between the sacrificial layer 110 and the structural layer 130. When current I passes through the conductive line 120, voltage V can be measured between two ends of the conductive line 120. After sacrificial layer 110 is removed, a fluid chamber is created. The fluid chamber is then enlarged by etching the silicon substrate 101 with KOH solution. Referring to FIG. 2G again, the conductive line 120 can be removed simultaneously by etching the silicon substrate. As soon as conductive line 120 is disrupted into lines 120a and 120b, current I passes through conductive line 120 reduced to 0, thereby monitoring etching process of the fluid chamber.

FIG. 2C is a cross section of a fluid injection device 100 filled with fluid during injection according to one embodiment of the invention. The fluid injection device 110 comprises a substrate 101, a structural layer 130, a fluid chamber 160, and a fluid channel 150. The structural layer 130 is disposed on the substrate 101. The fluid chamber 160 is formed between the substrate 101 and the structural layer 130 communicating with the fluid channel 150. At least one fluid actuator 170 is positioned on the structural layer 130 opposing the fluid chamber 160. A passivation layer 145 is disposed on the structural layer 130 covering the at least one actuator 170. A nozzle 180 is created neighboring the fluid actuator 170 and communicating with the fluid chamber 160 through the passivation layer 145 and the structural layer 130.

After opening the nozzle 180, fabrication of the injection device 100 is completed. Referring to FIG. 2C, the fluid chamber is filled with fluid through a manifold (not shown), the fluid channel 150. The fluid in the fluid chamber contacts lines 120a and 120b. The overall resistance can be contributed by resistance of line 120a, fluid in the chamber (length L), and line 120b, i.e., R=R₁+R_{1iq}+R₂, where R₁ R₂, and R_{1iq} are each resistance of line 120a, fluid in the chamber (length L), and line 120b respectively. More specifically, the electrical potential difference V_{f} between openings 135-135 can be expressed as V_{f}=I(R₁+R_{1iq}+R₂).

Although conductive line is adopted to monitor etching of the fluid chamber, other circuits comprising capacitors or resistor-capacitor hybrids can also applied in the invention. Other types of fluid injection devices, such as piezoelectric fluid injectors can also be applied using sensors to measure thickness of a deformable layer.

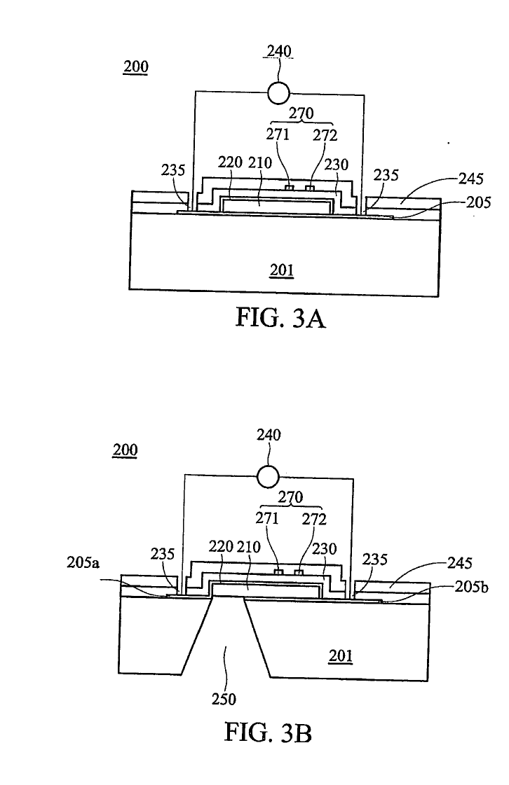

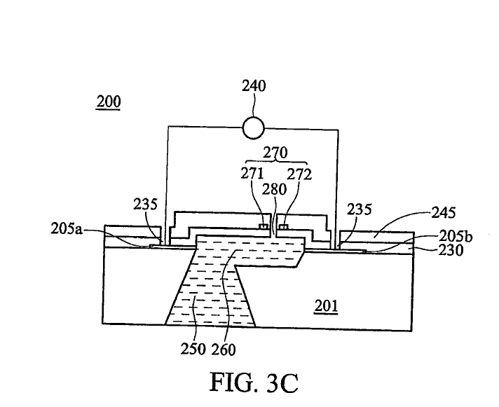

The invention also provides fluid injection devices with two parallel conductive lines acting as etching detectors and fabrication methods thereof. FIGS. 3A-3B are cross sections of an embodiment of a fabricating method for a fluid injection device according to the invention. FIG. 3C is a cross section of the fluid injection device of FIG. 3B filled with fluid.

Referring to 3A, the fluid injection device 200 may comprise two parallel conductive lines. The first conductive line 205 is disposed between substrate 201 and sacrificial layer 210. The second conductive line 220 is disposed between the sacrificial layer 210 and the structural layer 230. The passivation layer 245 covers the device. The first conductive line 205 and the second conductive line 220 can be parallel and contact at nodes N₁ and N₂. Alternatively, the first conductive line 205 and the second conductive line 220 can be independent. When current I passes through the conductive lines 205 and 220, voltage V₀ can be measured between two ends of the conductive lines. The resistance between two ends 235-235 is contributed by the first conductive line 205 and the second conductive line 220. After sacrificial layer 210 is removed, a fluid chamber 260 is created. The first conductive line 205 is disrupted. The resistance between two ends 235-235 is contributed by the second conductive line 220. The fluid chamber 260 is then enlarged by etching the silicon substrate 201 with KOH solution. Referring to FIG. 3B again, the conductive line 220 can be removed simultaneously of etching the silicon substrate. As soon as the second conductive line 220 is disrupted into lines 205a and 205b, voltage V passes through conductive line 220 reduced to 0, thereby monitoring etching process of the fluid chamber.

FIG. 3C is a cross section of a fluid injection device 300 filled with fluid during injection. The fluid chamber 260 is filled with fluid through a manifold (not shown), the fluid channel 250. The fluid in the fluid chamber 260 contacts lines 220a and 220b. The overall resistance between ends 235-235 can be supplied by each resistance of line 205a, fluid in the chamber 260 (length L), and line 205b, i.e., R=R₁+R_{1iq}+R₂, where R₁ R₂, and R_{1iq} are each resistance of line 205a, fluid in the chamber (length L), and line 205b respectively. More specifically, the electrical potential difference V_{f} between openings 235a, 235b can be expressed as V_{f}=I(R₁+R_{1iq}+R₂).

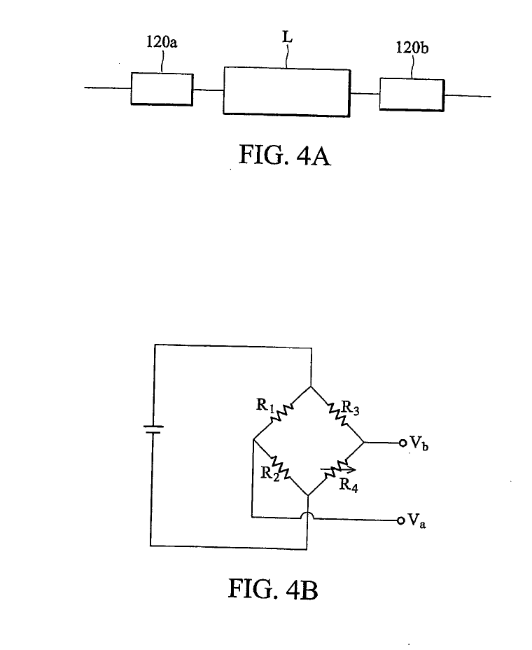

FIG. 4A is a schematic diagram of an equivalent circuit of line 120a, fluid in the chamber (length L), and line 120b according to an embodiment of the invention. The electrical potential difference V_{f} between openings 135-135 can be expressed as V_{f}=I(R₁+R_{1iq}+R₂). The fluid injection device can further couple to a Wheatstone bridge 410.

Referring to FIG. 4B, the electrical potential difference between Vₐ and V_{b} can be expressed as ΔV=V_{b}−Vₐ=Vᵢ(R₁R₄−R₂R₃)/((R₁+R₂)(R₃+R₄)). If R₁ equals R₂, the electrical potential difference ΔV=V_{b}−Vₐ=0.5Vᵢ(R₄−R₃)/(R₃+R₄). R₃ is approximately equal to R_{1iq}. When the conductive line is disrupted, i.e., R₄ is infinite, the electrical potential difference ΔV=V_{b}−Vₐ is approximately half of the input voltage V₀. When the fluid chamber 160 is filled with fluid, the electrical potential difference ΔV=V_{b}−Vₐ is approximately 0. Whether the fluid chamber is completely filled with fluid can be determined by measuring the electrical potential difference ΔV. For example, the equivalent resistance of ink is about several tens to hundreds thousand times higher than that of 33% KOH solution at 60° C. Accordingly, by adopting suitable Wheatstone bridges and circuits, etching of the fluid chamber and filling ink in the fluid chamber can be precisely monitored.

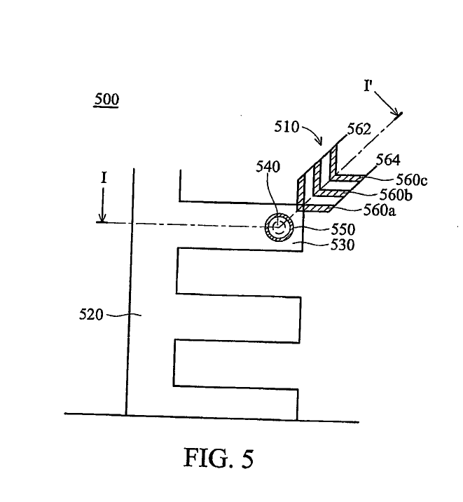

The invention further provides a fluid injection device with hybrid sensors. The sensor comprises combinations of multiple resistors and capacitors. FIG. 5 is a plan view of a fluid injection device 500 with hybrid sensors. A first sensor 550 is a cylindrical shell capacitor. The axial axis of the cylindrical shell capacitor is parallel to that of the nozzle 540. The resistor 510 is here disposed at the edge of the sacrificial layer 512.

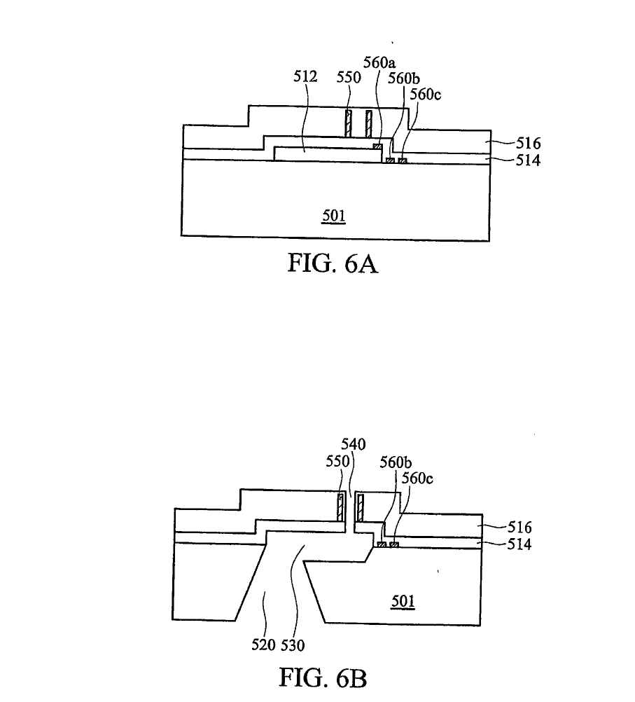

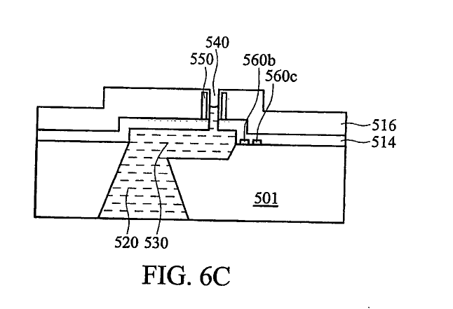

FIGS. 6A-6B are cross sections of methods for fabricating a fluid injection device 500 taken along line I-I′ of FIG. 5. FIG. 6C is a cross section of the fluid injection device 500 of FIG. 6B filled with fluid.

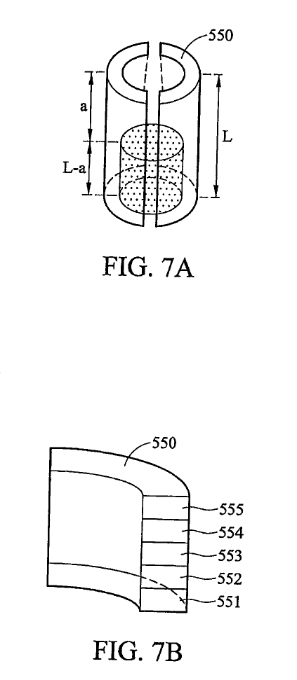

Here, hybrid sensors comprise the cylindrical shell capacitor 550 and parallel resistors 510. FIG. 7A is schematic view of the cylindrical shell capacitor 550. The electrodes of the cylindrical shell capacitor 550 are multi-layered conductive materials, comprising a heater layer such as TaAl, TiN, TiW, or Pt, an interconnecting metal layer such as Al—Si—Cu alloy or Al—Cu alloy, and a contact metal layer such as TiW or TiN. For process simplicity, the process of fabricating the cylindrical shell capacitor 550 is compatible with that of the semiconductor device. The cylindrical shell capacitor 550 can be embedded in the passivation layer 516. The core of the cylindrical shell capacitor 550 comprises nozzle 540.

The second sensor 510 may comprise resistors 560a, 560b, and 560c parallel with each other by conductive lines 562 and 564, for example. The resistor 560a may be disposed at the upper corner between the sacrificial layer 512 and structural layer 514. A portion of the resistor 560a may contact the surface of the sacrificial layer 512. The resistors 560b and 560c may be disposed at the bottom corner between the sacrificial layer 512, the sacrificial layer 514, and the substrate 501.

Filling of the fluid in the nozzle can be monitored by determining changes in the cylindrical shell capacitor 550. As described hereinbefore, etching of the fluid chamber and filling ink in the fluid chamber can be precisely monitored by the second sensor 510, as shown in FIG. 6C.

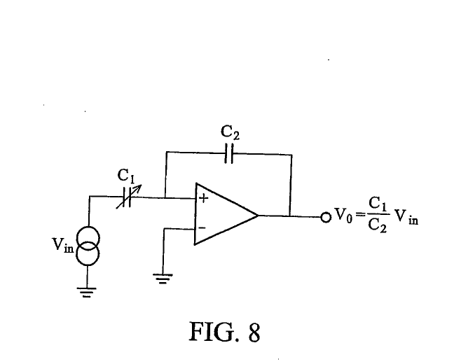

FIG. 8 is an equivalent circuit of capacitors C₁ and C₂ coupled to an operational amplifier. The circuit may further couple to a non-overlapping circuit (not shown). The output voltage of the circuit can be calculated by:

$${V}_{O} \frac{{C}_{1}}{{C}_{2}} \times {V}_{in}$$

where Vᵢₙ is input voltage, C₂ is a predetermined capacitor, C₁ is the capacitance of the cylindrical shell capacitor 550 with radius r and height L, as shown in FIG. 7A. The electrodes of the cylindrical shell capacitor 550 may be multi-layered conductive materials, comprising a heater layer such as TaAl, TiN, TiW, or Pt, a interconnect metal layer such as Al—Si—Cu alloy or Al—Cu alloy, and a contact metal layer such as TiW or TiN, for example. When the height of the fluid in the nozzle is L−a, the capacitance of the cylindrical shell capacitor 550 can be calculated by:

$${C}_{1} = \frac{{ɛ}_{0} {ɛ}_{f} π a ( L - a )}{2 [ {ɛ}_{0} a + {ɛ}_{f} ( L - a ) ]}$$

where ∈₀, ∈_{f} are dielectric constants of air and fluid respectively. When C₂, L, ∈₀, ∈_{f}, and Vₒ/Vᵢₙ are known, L−a can be calculated. The instant depth of fluid in the nozzle can be a determination of the driving parameters of the fluid injection device.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fluid injection device, comprising:
a substrate;
a fluid chamber in the substrate with a structural layer thereon;
at least one fluid actuator positioned on the structural layer;
a line shape resistive sensor communicating with the fluid chamber;
a passivation layer on the structural layer covering the at least one actuator and the sensor; and
a nozzle neighboring the fluid actuator and communicating with the fluid chamber through the passivation layer and the structural layer.

2. The device as claimed in claim 1, wherein the resistive heaters comprise:
a first heater disposed on the structural layer outside the fluid chamber to generate a first bubble in the fluid chamber; and
a second heater disposed on the structural layer outside the fluid chamber to generate a second bubble in the fluid chamber.

3. The device as claimed in claim 1, wherein the structural layer is low stress silicon nitride.

4. The device as claimed in claim 1, wherein the linear resistive sensor comprises a plurality of parallel resistors.

5. The device as claimed in claim 1, wherein the linear resistive sensor monitors formation of the fluid chamber to prevent overetching of the structure.

6. The device as claimed in claim 1, wherein the linear resistive sensor is in series with the fluid when the fluid chamber is filled.

7. A fluid injection device, comprising:
a substrate;
a fluid chamber in the substrate with a structural layer thereon;
at least one fluid actuator positioned on the structural layer;
a passivation layer on the structural layer covering the at least one actuator and the sensor;
a nozzle neighboring the fluid actuator and communicating with the fluid chamber through the passivation layer and the structural layer; and
a cylinder shell sensor on the structural layer mounted in the passivation layer about the nozzle.

8. The device as claimed in claim 7, wherein the cylinder shell sensor comprises a pair of semicircular electrodes.

9. The device as claimed in claim 8, the pair of semicircle electrodes are multi-level conductors.

10. The device as claimed in claim 9, wherein the multi-level conductor is TaAl, TiN, TiW, Pt, Al—Si—Cu alloy or Al—Cu alloy.

11. The device as claimed in claim 7, wherein when the fluid chamber is filled with fluid, the fluid fills the nozzle to a specific level by capillarity, wherein the specific level is measured by cylinder shell sensor, thereby adjusting the fluid injector heating time.

12. The device as claimed in claim 7, further comprising at least one linear resistive element connecting the fluid chamber.

13. A method for fabricating a fluid injection device, comprising:
providing a substrate;
forming a patterned sacrificial layer on the substrate;
forming a linear resistive sensor on the sacrificial layer, comprising a first end and a second end;
forming a patterned structural layer on the substrate and covering the sacrificial layer and the linear resistive sensor exposing the first end and the second end;
forming a fluid chamber in the body of the substrate, exposing the sacrificial layer; and
removing the sacrificial layer to form a fluid chamber.

14. The method as claimed in claim 13, wherein the linear resistive sensor comprises polysilicon or conductive material.

15. The method as claimed in claim 13, wherein removal of the sacrificial layer comprises wet etching of the sacrificial layer using an etching solution.

16. The method as claimed in claim 15, wherein removal of the sacrificial layer comprises applying a potential difference between the first end and the second end to acquire a electrical current.

17. The method as claimed in claim 16, when the electrical current is totally contributed by the linear resistive sensor, continuing etching the sacrificial layer.

18. The method as claimed in claim 16, when the electric current is totally contributed by etching solution, stop etching the sacrificial layer.

19. The method as claimed in claim 13, wherein the liner resistive sensor comprises a plurality of parallel resistors.

20. The method as claimed in claim 19, wherein the plurality of parallel resistors comprises a first resistor at the interface between the sacrificial layer and the structural layer, and a second resistor at the interface between the sacrificial layer and the substrate.

21. The method as claimed in claim 20, wherein removal of the sacrificial layer comprises applying a potential difference between the first end and the second end to acquire a electrical current, wherein if the electrical current is totally contributed by the linear resistive sensor, continuing to etch the sacrificial layer; and if the electric current is totally contributed by etching solution, to stop etching the sacrificial layer.
